(19) United States
(12) Patent Application Publication
(10) Pub. No.: US 2026/0084332 A1
(43) Pub. Date: Mar. 26, 2026

(54) SIZE-REDUCTION MACHINES AND COMPONENTS THEREOF

(71) Applicant: Urschel Laboratories, Inc., Chesterton, IN (US)

(72) Inventors: Dustin J. Gereg, Valparaiso, IN (US); William Monroe, Valparaiso, IN (US)

(21) Appl. No.: 19/331,576

(22) Filed: Sep. 17, 2025

Related U.S. Application Data
(60) Provisional application No. 63/697,827, filed on Sep. 23, 2024.

(51) Int. Cl. B26D 7/22; B26D 7/00; B26D 7/06

(52) U.S. Cl. CPC B26D 7/22; B26D 2007/0018; B26D 7/0691; B26D 2210/02

(57) ABSTRACT

Size-reduction machines for producing reduced-size products, and product discharge units of size-reduction machines.

### CROSS-REFERENCE TO RELATED APPLICATIONS

This application claims the benefit of provisional U.S. patent application Ser. No. 63/697,827 filed Sep. 23, 2024, the contents of which are incorporated herein by reference.

### BACKGROUND OF THE INVENTION

The present invention generally relates to methods and machines for cutting solid and semisolid materials, including food products. The invention particularly relates to size-reduction machines and methods for producing sliced, strip, and diced products.

The DiversaCut Sprint7 dicer is a nonlimiting example of a size-reduction machine manufactured by Urschel Laboratories, Inc., and is particularly well suited for slicing, strip-cutting, and dicing various materials, notable but nonlimiting examples of which include vegetables, fruits, and meats. The DiversaCut Sprint7 dicer is well known as capable of high-capacity output and precision cuts, as well as for its versatility to be capable of making a variety of cut sizes and types to produce a wide variety of products.

A nonlimiting representation of a cutting section of a DiversaCut Sprint7 size-reduction machine 10 is shown in FIG. 1. Products 16 are delivered to the machine 10, for example, through a feed hopper (not shown), and enters a rotating impeller 12 through an axial opening of the impeller 12. The impeller 12 is equipped with paddles 14 and as the impeller 12 rotates centrifugal forces hold the products 16 against an inner wall 18 of a stationary case 20 equipped with a slicing knife 22. The slicing knife 22 is typically oriented approximately parallel to the generally horizontal rotational axis 24 that is common to the impeller 12 and case 20, and is disposed in or adjacent an opening in the case 14 that defines an outlet of the impeller 12. The paddles 14 of the impeller 12 carry the products 16 to the slicing knife 22, producing slices 26 that exit the case 20. In the nonlimiting embodiment shown, the slices 26 enter a size-reduction unit 28 of the machine 10. As used herein, the size-reduction unit 28 comprises a part of the machine 10 downstream of the slicing knife 22 and generally includes a circular cutter 30 that cuts the slices 26 into strips, which are then diced by crosscut knives 34 of a cross-cutter 32 to produce a diced product 36. Both the circular cutter 30 and the cross-cutter 32 rotate about their respective axes of rotation. The cross-cutter 32 can be removed so that the strips are the final product of the machine 10, and the circular cutter 30 can also be removed so that the slices 26 are the final products of the machine 10. FIG. 1 depicts the product 36 as discharged through a product discharge chute 46 capable of discharging processed product from the machine 10 after being reduced in size.

Though slice thickness is not critical for every application, slices having a controlled and uniform thickness are desirable and possibly even critical for others. The thicknesses of slices 26 produced with the machine 10 of FIG. 1 are determined by a moveable gate 38 positioned ahead of, or “leading,” the slicing knife 22. The gate 38 is represented as pivotably coupled to the case 20 at a leading end 40 of the gate 38, and pivoted by an adjustment device 44 located adjacent a trailing end 42 of the gate 38. As used herein, “leading” (and related forms thereof) refers to a position on the case 20 (or a component thereof) that is ahead of or precedes another in the direction of rotation of the impeller 12 within the case 20, whereas “trailing” (and related forms thereof) refers to a position on the case 20 (or a component thereof) that follows or succeeds another relative to the rotational direction of the impeller 12. As such, the case 20 can be characterized as having a leading direction, a trailing direction opposite the leading direction, an axial direction perpendicular to the leading and trailing directions. Because the impeller 12 and case 20 are substantially coaxial, the impeller 12 and case 20 can also be characterized as having a radial direction that passes through the axis 24 of the impeller 12 and is perpendicular to the leading, trailing, and radial directions.

While size-reduction machines such as the DiversaCut Sprint7 have performed extremely well for their intended purpose, there is an ongoing desire for improvements in machines of this type.

### BRIEF DESCRIPTION OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, size-reduction machines and methods capable of producing a variety of sliced, strip, and/or diced products.

According to a nonlimiting aspect of the invention, a size-reduction machine includes a size-reduction unit and a product discharge unit for discharging processed product from the machine after being reduced in size by the size-reduction unit. The product discharge unit includes deflectors located at an exit of the size-reduction unit and defining a discharge passage therebetween, and a safety enclosure assembly adapted to prevent access to the size-reduction unit and interior components of the product discharge unit.

Other aspects and advantages of this invention will be better appreciated from the following detailed description.

### BRIEF DESCRIPTION OF THE DRAWINGS

FIG. 1 schematically represents a nonlimiting example of a size-reduction machine comprising an impeller rotating within a case on a substantially horizontal axis.

FIGS. 2 through 5 represent a size-reduction machine of the type represented in FIG. 1, wherein the machine is equipped with product discharge units that are adapted to discharge processed products from the machine.

FIGS. 6 and 7 represent alternative configurations of deflectors suitable for use with the product discharge units of FIGS. 2 through 5.

FIG. 8 represents a size-reduction machine similar to the machine of FIGS. 2 through 5 and capable of being equipped with any of the product discharge units thereof, wherein the machine further includes a safety enclosure assembly adapted to prevent access to the product discharge unit during operation of the machine.

FIGS. 9 through 13 represent different operational stages of the safety enclosure assembly of FIG. 8.

### DETAILED DESCRIPTION OF THE INVENTION

The intended purpose of the following detailed description of the invention and the phraseology and terminology employed therein is to describe what is shown in the drawings, which include the depiction of and/or relate to one or more nonlimiting embodiments of the invention, and to describe certain but not all aspects of what is depicted in the drawings, including the embodiment(s). The following detailed description also identifies certain but not all alternatives of the embodiment(s) depicted in the drawings. As nonlimiting examples, the invention encompasses additional or alternative embodiments in which one or more features or aspects shown and/or described as part of a particular embodiment could be eliminated, and also encompasses additional or alternative embodiments that combine two or more features or aspects shown and/or described as part of different embodiments. Therefore, the appended claims, and not the detailed description, are intended to recite what at least provisionally are believed to be aspects of the invention, including certain but not necessarily all of the aspects and alternatives described in the detailed description.

Some of the drawings may disclose certain dimensions or other aspects of various components that are believed to be exemplary, but are otherwise not necessarily limitations to the scope of the invention.

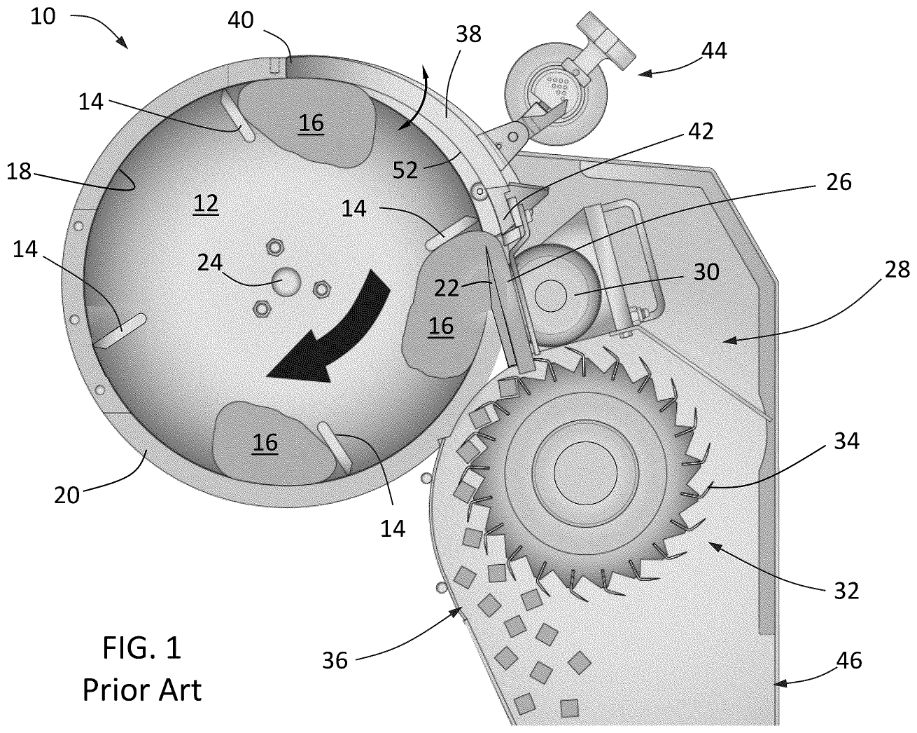

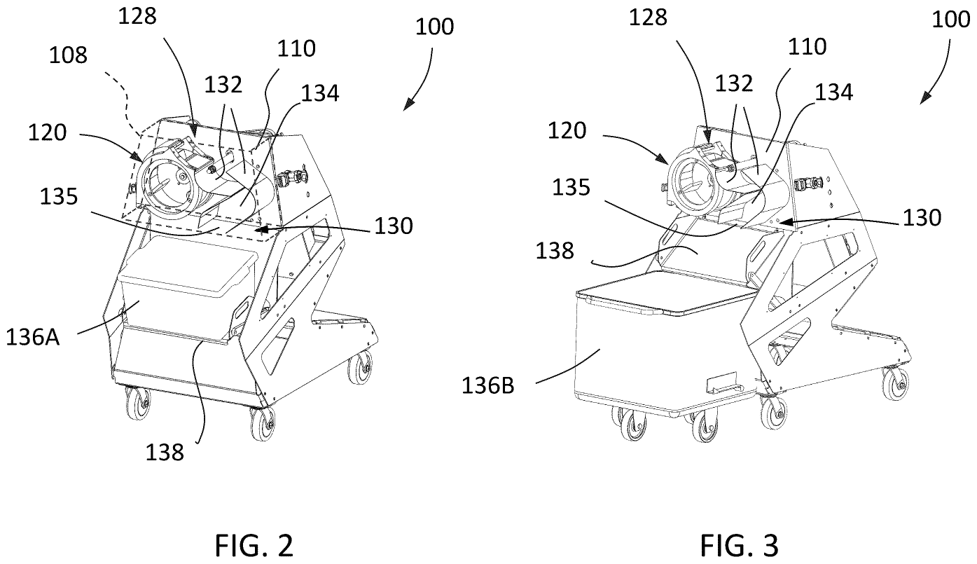

FIGS. 2 through 5 schematically represent a size-reduction machine 100 disclosed in copending U.S. patent application Ser. No. 63/520,802 filed Aug. 21, 2023, whose contents are incorporated herein by reference, and FIGS. 2 through 7 schematically represent product discharge units 130 capable of use with the size-reduction machine 100. The discharge units 130 are not limited to the machine 100 and can be adapted for installation on other size-reduction machines, as a nonlimiting example, the DiversaCut Sprint7 machine 10 represented in FIG. 1. However, the following discussion will make reference to the size-reduction machine 100 of FIGS. 2 through 5, and consistent reference numbers are used in FIGS. 2 through 7 to identify components that are the same or functionally equivalent. Other aspects not discussed in any detail may be, in terms of structure, function, materials, etc., essentially as was described for FIG. 1.

Referring to FIG. 1, it can be seen that the product 36 drops vertically downward from the size-reduction unit 28 of the machine 10 along a roughly linear discharge path through the discharge chute 46, whose vertical length can be adapted to prevent an operator of the machine 10 from being able to reach up through the chute 46 to come in contact with the cross-cutter 32 or other components of the size-reduction unit 28. However, if a more compact design is desired for the size-reduction unit 28, the discharge chute 46, or the entire machine 10 as a whole, a linear discharge path for products may not be suitable for reasons of operator safety.

FIGS. 2 and 3 represent the product discharge unit 130 incorporated into the size-reduction machine 100 to discharge processed product from the machine 100 after being reduced in size by a size-reduction unit 128 located downstream of a slicing knife (not shown) installed on a case 120 of the machine 100. The discharge unit 130 comprises a pair of deflectors 132 that are located at the exit of the size-reduction unit 128 and define a discharge passage 134 therebetween. The deflectors 132 extend horizontally outward from a wall 110 from which the case 120 also extends horizontally, such that products (not shown) exiting the case 120 travel downward from the size-reduction unit 128 of the machine 100 through the discharge passage 134. The discharge unit 130 preferably further includes an enclosure 108 (schematically shown in phantom in FIG. 2) installed on the wall 110 to entirely enclose the case 120 and the deflectors 132 except for a lower exit 135 of the discharge passage 134 through which products exit the machine 100. In FIG. 2, the deflectors 132 and the exit 135 conduct the product directly into a bin 136A supported on a tray 138. In FIG. 3, the tray 138 has been pivoted upward to serve as a chute for conducting the product from the exit 135 of the discharge passage 134 into a bin 136B depicted as self-supporting.

The deflectors 132 serve as baffles for decelerating products passing through the discharge passage 134 after being processed with the size-reduction unit 128 of the machine 100. The deflectors 132 are represented as generally V-shaped and/or U-shaped, causing products traveling downward through the discharge passage 134 to follow a nonlinear path (generally a V-shaped or U-shaped curved path) between the deflectors 132. In the embodiment shown in FIGS. 2 and 3, the deflector 132 nearest the case 120 is V-shaped and defines the interior corner of the discharge passage 134, and the deflector 132 farthest from the case 120 is U-shaped and defines the exterior corner of the discharge passage 134. Deceleration of product largely occurs as a result of the product exiting the size-reduction unit 128 contacting the deflector 132 that defines the exterior corner of the discharge passage 134 and the resulting abrupt change in direction caused thereby. Whether the deflectors 132 are V-shaped or U-shaped, the resulting discharge unit 130 creates a tortuous path that, in addition to decelerating product, also promotes safety while the machine 100 is operating (and the enclosure 108 is installed on the wall 110) by preventing the operator (or other individual) from being able to access the moving machinery downstream of the case 120 and above the discharge unit 130 (e.g., a cross-cutter such as shown in FIG. 1) by way of the exit 135 of the discharge passage 134 located above the bins 136A and 136B.

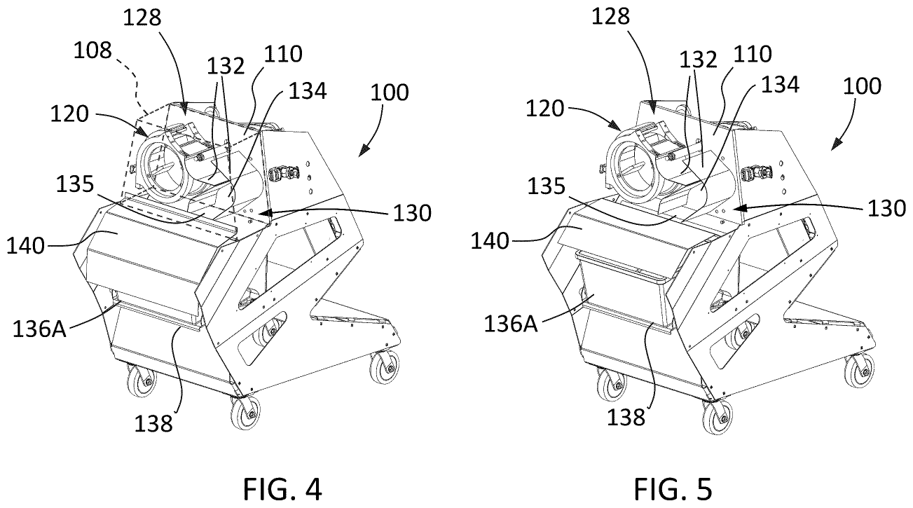

In FIGS. 4 and 5, the product discharge unit 130 is represented as further including a discharge door 140 adapted to translate for the purpose of covering the bin 136A and simultaneously exposing the exit 135 of the discharge passage 134 to allow products to enter the bin 136A. As shown in FIG. 4, with the enclosure 108 (again shown in phantom) installed on the wall 110, the discharge door 140 effectively increases the length of the tortuous path already created by the discharge passage 134 to prevent the operator (or other individual) from being able to access the moving machinery above the discharge unit 130 through the exposed exit 135 of the discharge passage 134, and is effective for this purpose even if the bin 136A were to be removed. In FIG. 5, the door 140 is shown as having been translated to block the exit 135 of the discharge passage 134 and provide access to the bin 136A, enabling the bin 136A to be removed from the machine 100. In this position, the door 140 cooperates with the enclosure 108 to completely block access to the moving machinery above the discharge unit 130.

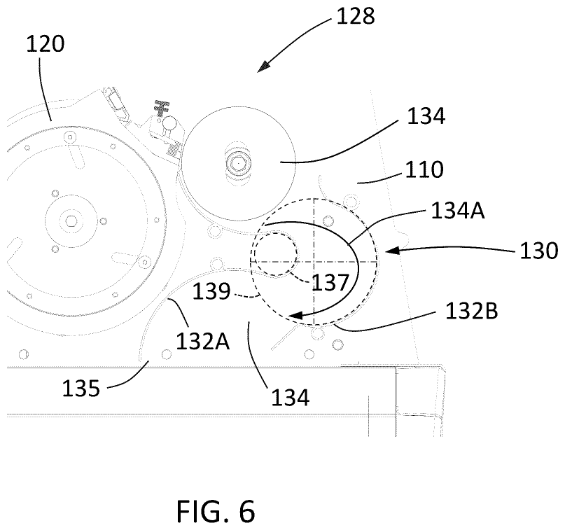

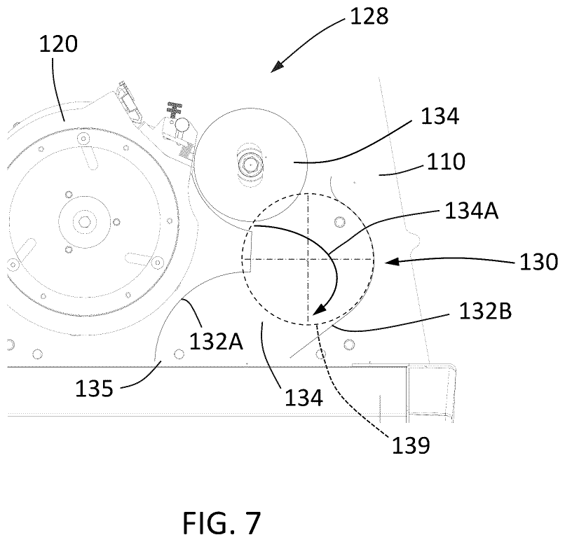

FIGS. 6 and 7 represent additional possible configurations for the deflectors 132, which are labeled as deflectors 132A and 132B to identify the deflectors 132 as defining the interior or exterior corner, respectively, of the generally U-shaped curved path 134A of the discharge passage 134. The different deflectors 132A and 132B and their resulting different discharge passages 134 represented in FIGS. 6 and 7 provide for different deceleration rates for different products that might be processed with the machine 100.

In FIG. 6, both deflectors 132A and 132B are represented as generally U-shaped, with the deflector 132A defining the interior corner of the discharge passage 134 having a smaller radius of curvature 137 than the radius of curvature 139 of the deflector 132B defining the exterior corner of the discharge passage 134. In addition, the deflector 132A extends sufficiently far into the curvature 137 of the deflector 132B so that a product cannot vertically drop immediately from the deflector 132A through the passage 134 without encountering the deflector 132B. In so doing, the resulting tortuous path 134A through the discharge passage 134 promotes safety while the machine 100 is operating (and with the enclosure 108 installed on the wall 110) by preventing the operator (or other individual) from being able to access the moving machinery above the discharge unit 130 by way of the exit 135 of the discharge passage 134.

In FIG. 7, the deflector 132A defining the interior corner of the discharge passage 134 is truncated so that a product vertically dropping immediately from the deflector 132A through the passage 134 will not encounter the deflector 132B. The configuration of FIG. 7 promotes the free flow of products through the discharge passage 134, but results in the path 134A through the discharge passage 134 being less tortuous than the path 134A in FIG. 6.

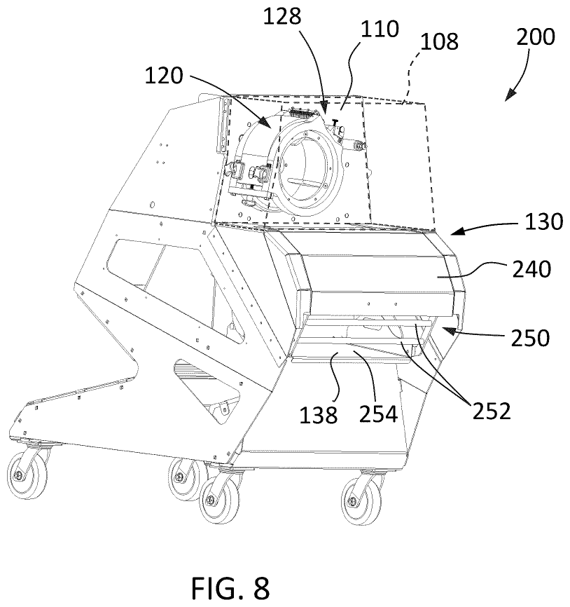

FIG. 8 schematically represents a size-reduction machine 200 similar to that disclosed in copending U.S. patent application Ser. No. 63/520,802 and similar to the machine 100 represented in FIGS. 2 through 5, including the deflectors 132, 132A, and 132B (not shown in FIG. 8) of any of the product discharge units 130 represented in FIGS. 2 through 7. Therefore, consistent reference numbers are used in FIG. 8 to identify components that are the same or functionally equivalent to those of FIGS. 2 through 7. Other aspects not discussed in any detail may be, in terms of structure, function, materials, etc., essentially as was described for FIGS. 1 through 7.

In FIG. 8, the discharge unit 130 of the machine 200 is represented as further including a safety enclosure assembly 250 adapted to prevent access to the size-reduction unit 128 and also interior components of the product discharge unit 130 during operation of the machine 200. Similar to the machine 100 of FIGS. 4 and 5, the enclosure assembly 250 includes a discharge door 240 for the purpose of covering a bin (such as the bin 136A of FIGS. 4 and 5) resting on the tray 138 and simultaneously exposing the exit 135 of the discharge passage 134 to allow products to enter the bin. In FIG. 8, with the door 240 positioned to expose the exit 135 of the discharge passage 134, the door 240 and enclosure 108 (shown in phantom) installed on the wall 110 cooperate to effectively increase the length of the tortuous path already created by the discharge passage 134 to prevent the operator (or other individual) from being able to access the moving machinery above the discharge unit 130 through the exposed exit 135 of the discharge passage 134, and is effective for this purpose even if a bin is not positioned on the tray 138. Also similar to the door 140 of FIGS. 4 and 5, the door 240 is adapted to be translated to block the exit 135 of the discharge passage 134 and provide access to a bin placed on the tray 138, enabling the bin to be removed from the machine 200 while cooperating with the enclosure 108 to completely block access to the moving machinery above the discharge unit 130.

The enclosure assembly 250 is represented in FIG. 8 as further including bars 252 that create a safety barrier that impedes if not prevents access to the interior of the enclosure assembly 250 and a bin within the interior of the enclosure assembly 250, as well as to the exit 135 of the discharge passage 134 while the exit 135 is exposed by the door 240. An opening 254 can be seen to exist between the tray 138 and the lower extent of the door 240, and the bars 252 are preferably spaced apart from each other so that gaps therebetween are limited in size, as a nonlimiting example, a distance between bars 252 of less than an inch (2.5 cm), so that the tray 138 and a bin sitting thereon cannot be accessed or removed. As discussed below, the bars 252 are configured to pivot relative to the door 240 as the door 240 is translated between its different positions in which the exit 135 of the discharge passage 134 is exposed and closed.

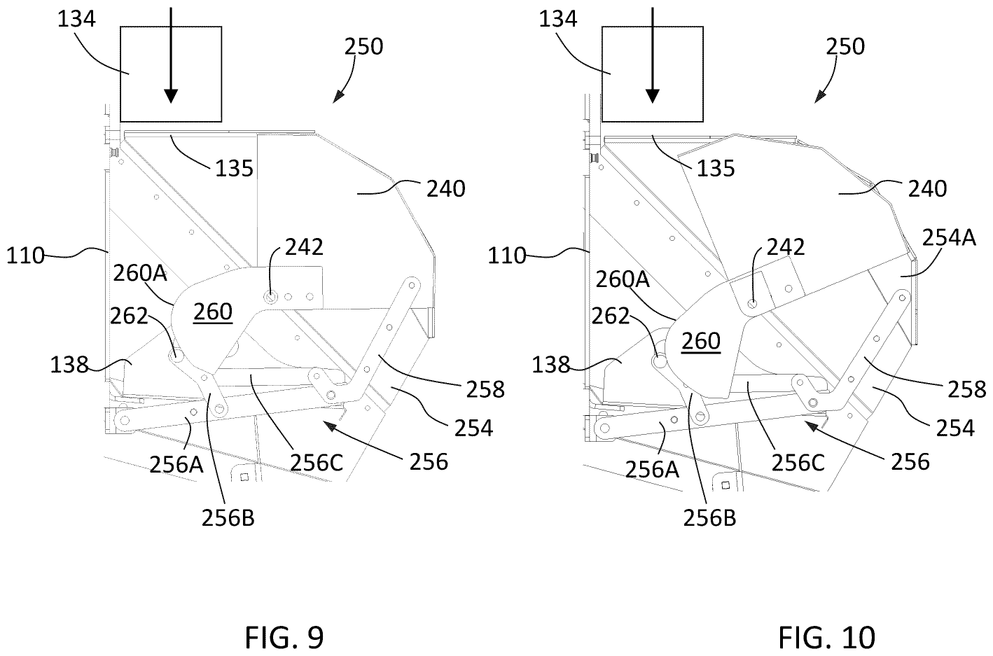

FIGS. 9 through 13 represent different operational stages of the enclosure assembly 250 of FIG. 8. FIG. 9 represents a side view of the enclosure assembly 250 with the door 240 and bars 252 of the assembly 250 as shown in FIG. 8. As seen in FIG. 9, the door 240 is positioned such that the exit 135 of the discharge passage 134 is exposed, allowing product to drop down through the exit 135 and enter a bin (not shown) placed on the tray 138. The door 240 is pivotally mounted to the machine 200 at a bearing 242 or other means for enabling the door 240 to pivot. The door 240 and bars 252 are interconnected through a mechanical linkage assembly 256 that includes at least one link (hereinafter, bar link) 258 that couples the bars 252 together, at least one cam 260 affixed to the door 240 for pivotal movement therewith about the axis of the bearing 242, and at least one cam follower 262 that cams against a cam contour 260A of the cam 260. The linkage assembly 256 causes the bar link 258 and bars 252 to pivot as the door 240 is pivoted and the cam follower 262 cams against the cam contour 260A of the cam 260.

In the nonlimiting embodiment shown, the linkage assembly 256 is a four-bar linkage comprising a first link 256A to which the bar link 258 and a second link 256 are both pivotally connected. The cam follower 262 is mounted to the second link 256B, and a third link 256C pivotally couples the second link 256B to the bar link 258. Though a particular linkage assembly 256 is shown, various other linkage assemblies could be used to synchronize the movements of the door 240 and bars 252. Additionally, it is foreseeable that devices other than a mechanical linkage assembly could be used, as nonlimiting examples, electric, hydraulic, and/or pneumatic actuators.

As seen in FIG. 10, the door 240 has been pivoted upward to partially close the exit 135 of the discharge passage 134. Though the cam follower 262 has cammed against a first portion of the cam contour 260A of the cam 260, the linkage assembly 256 has not caused the bar link 258 and bars 252 to pivot during this limited pivoting of the door 240, with the result that an entrance 254A has been created between the uppermost bar 252 and the lower extent of the door 240, but the entrance 254A is not larger than the gaps between adjacent bars 252. As such, with the exit 135 to the discharge passage 134 still partially exposed by the door 240, the bars 252 remain as a barrier to the interior of the enclosure assembly 250 as a result of being located within the opening 254 between the tray 138 and the lower extent of the door 240, and little if any risk is posed to the operator while the machine 200 continues to run due to the inaccessibility of the exit 135 of the discharge passage 134.

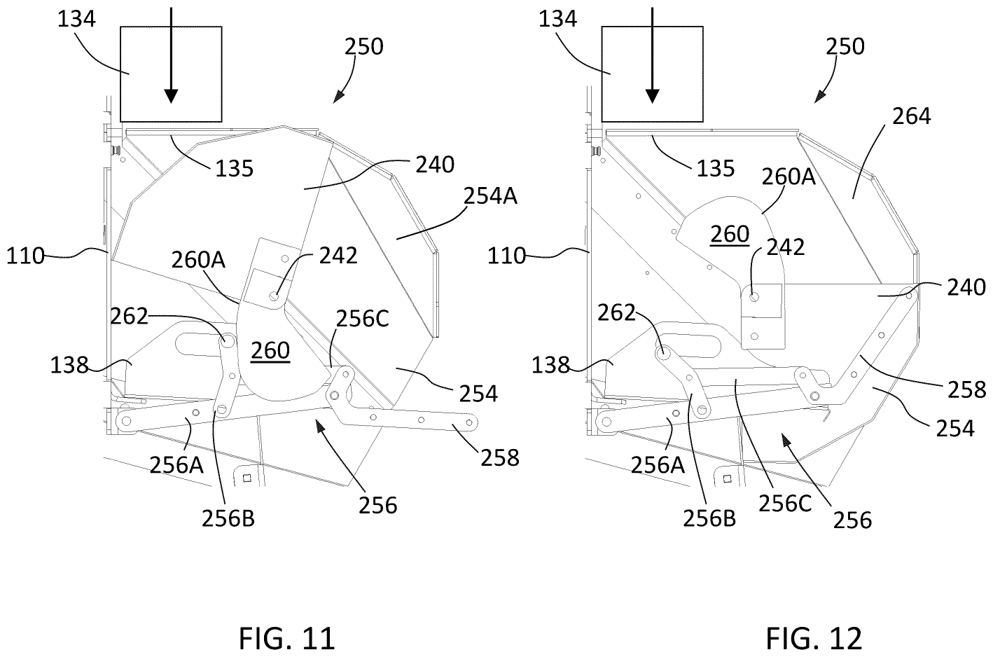

As seen in FIG. 11, the door 240 has been pivoted farther upward so that the exit 135 of the discharge passage 134 is now entirely closed by the door 240 and the size of the entrance 254A has been greatly increased. Additionally, the cam follower 262 now cams against a second portion of the cam contour 260A of the cam 260, such that the linkage assembly 256 has caused the bar link 258 and bars 252 to pivot downward to fully expose the opening 254 adjacent the tray 138, giving free access to the interior of the enclosure assembly 250, the tray 138 therein, and any bin on the tray 138 through the combination of the opening 254 and entrance 254A. With the exit 135 of the discharge passage 134 completely closed, there is no risk posed to the operator while the machine 200 continues to run.

FIG. 12 represents an optional capability of the door 240 to be pivoted downward from the position shown in FIGS. 8 and 9, creating a large opening 264 above the door 240 that permits cleaning or other desired serving or maintenance of the machine 200.

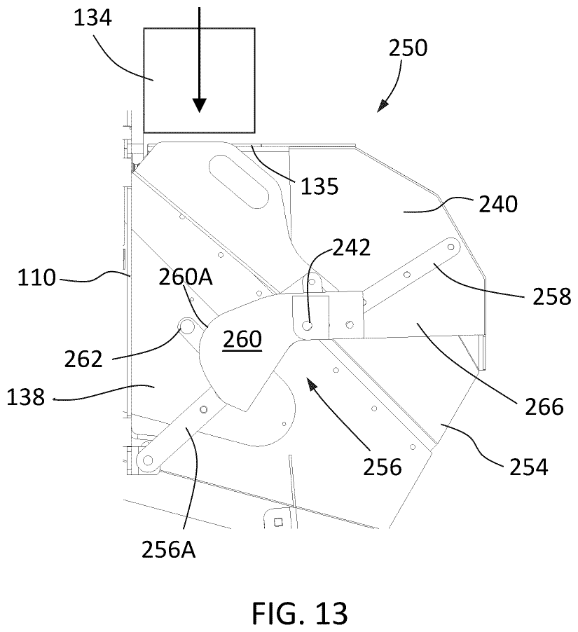

FIG. 13 represents an optional capability of the tray 138 to be repositioned as a sloping chute for products dropping through the exit 135 of the discharge passage 134. With the door 240 positioned as shown in FIGS. 8 and 9, the tray 138 has been tilted with an edge adjacent the exit 135 secured to the wall 110, creating a chute exit 266 between the lower extent of the door 240 and the lower end of the tray 138. The tray 138 is interconnected by the linkage assembly 256 to the bar link 258 so that the bars 252 are positioned within the chute exit 266, creating a barrier within the chute exit 266 so that little if any risk is posed to the operator while the machine 200 continues to run due to the inaccessibility of the exit 135 of the discharge passage 134.

While the invention has been described in terms of a specific or particular embodiment, it is apparent that alternatives could be adopted by one skilled in the art. For example, the size-reduction machine and its components could differ in appearance and construction from the embodiments described herein and shown in the drawings, functions of certain components of the machine could be performed by components of different construction but capable of a similar (though not necessarily equivalent) function, and various materials could be used in the fabrication of the machine and its components. Accordingly, it should be understood that the invention is not necessarily limited to any embodiment described herein or illustrated in the drawings.

1. A size-reduction machine comprising a size-reduction unit and a product discharge unit for discharging processed product from the machine after being reduced in size by the size-reduction unit, the product discharge unit comprising:
deflectors located at an exit of the size-reduction unit and defining a discharge passage therebetween; and
a safety enclosure assembly adapted to prevent access to the size-reduction unit and interior components of the product discharge unit.

2. The size-reduction machine of claim 1, wherein the safety enclosure assembly comprises a discharge door and bars that are adapted to pivot to expose an exit of the discharge passage and simultaneously create a barrier to an interior of the safety enclosure assembly, and adapted to pivot to close the exit of the discharge passage and simultaneously provide access to the interior of the enclosure assembly.
